(19) United States
(12) Patent Application Publication
(10) Pub. No.: US 2013/0085664 A1
(43) Pub. Date: Apr. 4, 2013

(54) APPARATUS AND METHOD FOR DETECTING HEADING CHANGE IN MOBILE TERMINAL

(71) Applicants: Sung-Min PARK, Seoul (KR); Kyong-Ha Park, Suwon-si (KR)

(72) Inventors: Sung-Min PARK, Seoul (KR); Kyong-Ha Park, Suwon-si (KR)

(73) Assignee: Samsung Electronics Co., Ltd., Suwon-si (KR)

(21) Appl. No.: 13/444,446

(22) Filed: Apr. 11, 2012

(30) Foreign Application Priority Data
Sep. 30, 2011 (KR) 10-2011-0099803

(51) Int. Cl. G01C 21/34; G06F 15/00

(52) U.S. Cl. 701/411; 702/141

(57) ABSTRACT

An apparatus and a method for detecting a heading change of a navigating body to which a mobile terminal has been attached are provided. The mobile terminal includes at least one measure unit and a change vector calculator. The at least one measure unit measures at least one of an acceleration of gravity component vector and a rotational axis component vector, with respect to a rotation of the navigating body, on a terminal coordinate system that is fixed in the mobile terminal. The change vector calculator calculates a horizontal heading change vector and a vertical heading change vector based on at least one of the acceleration of gravity component vector and the rotational axis component vector.

### PRIORITY

The present application claims priority under 35 U.S.C. §119(a) to a Korean patent application, which was filed in the Korean Intellectual Property Office on Sep. 30, 2011, and assigned Serial No. 10-2011-0099803, the entire disclosure of which is incorporated herein by reference.

### BACKGROUND OF THE INVENTION

1. Field of the Invention

The present invention relates generally to a mobile terminal.

2. Description of the Related Art

Generally, navigation equipment is installed in most navigating bodies, such as, for example, a vehicle or an airplane. The navigation equipment receives a position determination value for a current position of a navigating body from a Global Positioning System (GPS) satellite, and then guides a path from the current position to a destination set by a user.

When displaying a path using a position determination value received from the GPS satellite, a path may not be displayed normally if an elevated road or a an underground road exists on the path, a road diverges inside an underground road, or an error occurs to a position determination value received from a GPS satellite. This abnormal display may confuse a user of the system.

### SUMMARY OF THE INVENTION

The present invention has been made to address at least the above problems and/or disadvantages and to provide at least the advantages described below. Accordingly, an aspect of the present invention provides an apparatus and a method for detecting a heading change depending on an operation of a navigating body in a mobile terminal attachable/detachable to/from the navigating body.

Another aspect of the present invention provides an apparatus and a method for accurately displaying a position of a navigating body by detecting a heading change even when a branching road exists or an error is generated to a position determination signal, while displaying a path from a current position of the navigating body to a destination using a mobile terminal attachable/detachable to/from the navigating body.

In accordance with an aspect of the present invention, a mobile terminal that is attachable to and detachable from a navigating body is provided. The mobile terminal includes at least one measure unit for measuring at least one of an acceleration of gravity component vector and a rotational axis component vector, with respect to a rotation of the navigating body, on a terminal coordinate system that is fixed in the mobile terminal. The mobile terminal also includes a change vector calculator for calculating a horizontal heading change vector and a vertical heading change vector based on at least one of the acceleration of gravity component vector and the rotational axis component vector.

In accordance with another aspect of the present invention, a method for operating a mobile terminal that is attachable to and detachable from a navigating body is provided. At least one of an acceleration of gravity component vector and a rotational axis component vector, with respect to a rotation of the navigating body, is measured on a terminal coordinate system that is fixed in the mobile terminal. A horizontal heading change vector and a vertical heading change vector are calculated based on at least one of the acceleration of gravity component vector and the rotational axis component vector.

In accordance with an additional aspect of the present invention, a mobile terminal is provided. The mobile terminal includes an acceleration of gravity measure unit for measuring an acceleration of gravity component vector on a terminal coordinate system that is fixed in the mobile terminal, and a rotational axis component measure unit for measuring a rotational axis component vector with respect to a rotation of a navigating body on the terminal coordinate system. The mobile terminal also includes a coordinate system transformer for transforming the measured acceleration of gravity component vector and the measured rotational axis component vector to respective components of a horizontal plane coordinate system that is fixed in a horizontal plane. The mobile terminal further includes a change vector calculator for calculating a horizontal heading change vector and a vertical heading change vector based on the acceleration of gravity component vector and the rotational axis component vector. The mobile terminal additionally includes a position determination value receiver for determining a current position of the navigating body, a display unit for displaying a path from the current position to a destination set by a user of the mobile terminal. The mobile terminal also includes a path corrector for, when a branching road exists on the path from the current position to the destination, or an error exists in the received position determination value, correcting the path of the navigating body based on the horizontal heading change vector and the vertical heading change vector.

### BRIEF DESCRIPTION OF THE DRAWINGS

The above and other aspects, features and advantages of the present invention will be more apparent from the following detailed description when taken in conjunction with the accompanying drawings, in which:

FIGS. 1A and 1B illustrate a terminal coordinate system and a horizontal plane coordinate system, according to an embodiment of the present invention;

FIG. 2 illustrates an acceleration of gravity component vector and a rotational axis component vector for a case where a navigating body rotates at a speed less than a set value on a horizontal plane whose roadbed is constant, according to an embodiment of the present invention;

FIG. 3 illustrates an acceleration of gravity component vector and a rotational axis component vector for a case where a navigating body drives in a straight line at a constant speed on a roadbed including at least one of an uphill road, a downhill road, and an uneven road, according to an embodiment of the present invention;

FIG. 4 illustrates an acceleration of gravity component vector and a rotational axis component vector for a case where a navigating body rotates at a speed less than a set value on a roadbed including at least one of an uphill road, a downhill road, and an uneven road, according to an embodiment of the present invention;

FIG. 5 is a block diagram illustrating a mobile terminal, according to an embodiment of the present invention;

FIG. 6 is a flowchart illustrating a procedure for detecting a heading change in a mobile terminal, according to an embodiment of the present invention;

FIG. 7 is a flowchart illustrating a procedure for displaying a path in a mobile terminal, according to an embodiment of the present invention; and

FIGS. 8A and 8B illustrate User Interfaces (UIs) for informing whether to diverge provided in a mobile terminal, according to an embodiment of the present invention.

### DETAILED DESCRIPTION OF EMBODIMENTS OF THE INVENTION

Embodiments of the present invention are described in detail with reference to the accompanying drawings. The same or similar components may be designated by the same or similar reference numerals although they are illustrated in different drawings. Detailed descriptions of constructions or processes known in the art may be omitted to avoid obscuring the subject matter of the present invention.

Embodiments of the present invention relate to an apparatus and a method for detecting a heading change of a navigating body, to which a mobile terminal has been attached, in the mobile terminal. Embodiments of the present invention provide a technology for detecting the heading change depending on an operation of a navigating body in a mobile terminal. A mobile terminal denotes, for example, a cellular phone, a Personal Communication System (PCS), a Personal Digital Assistant (PDA), an International Mobile Telecommunication-2000 (IMT-2000) terminal, a smart phone, or a Table Personal Computer (PC).

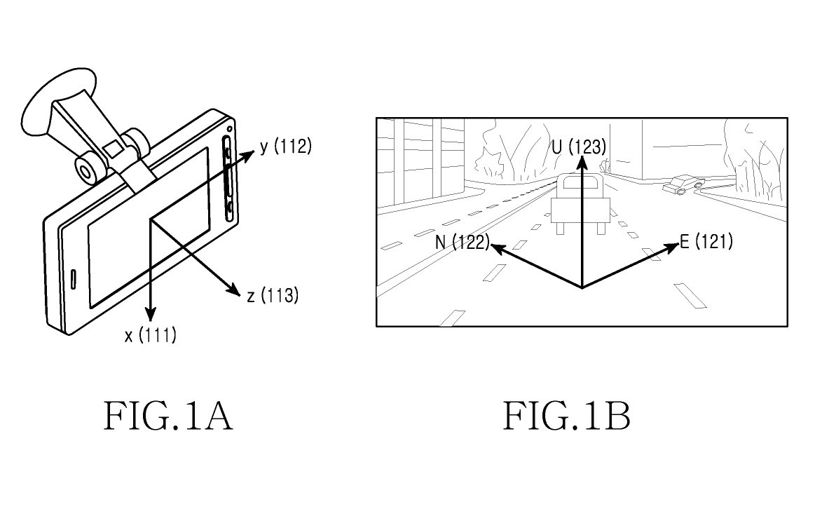

FIGS. 1A and 1B illustrate a terminal coordinate system and a horizontal plane coordinate system, according to an embodiment of the present invention. Referring to FIG. 1A, a mobile terminal, according to an embodiment of the present invention, may be installed in a navigating body, such as an automobile, an airplane, or a motorcycle, in a detachable manner. Embodiments of the present invention assume a terminal coordinate system that defines a down direction of the mobile terminal as an x-axis 111, a right direction of the mobile terminal as a y-axis 112, and a front direction of the screen as a z-axis 113. The terminal coordinate system is fixed in the mobile terminal. Specifically, a relative direction of the terminal coordinate system with respect to the mobile terminal does not change, but absolute directions of respective axes 111 to 113 of the terminal coordinate system may change depending on a position at which the mobile terminal has been installed, and a direction and movement of the navigating body. In addition, as shown in FIG. 1B, the present invention assumes a horizontal plane coordinate system configured with an East (E)-axis 121, a North (N) axis 122 with respect to a horizontal plane, and an Up (U)-axis 123 of an upper direction of the ground. Assuming that the horizontal plane is constant without a slope or unevenness, the horizontal plane coordinate system may be treated as it is fixed in the same direction regardless of a position.

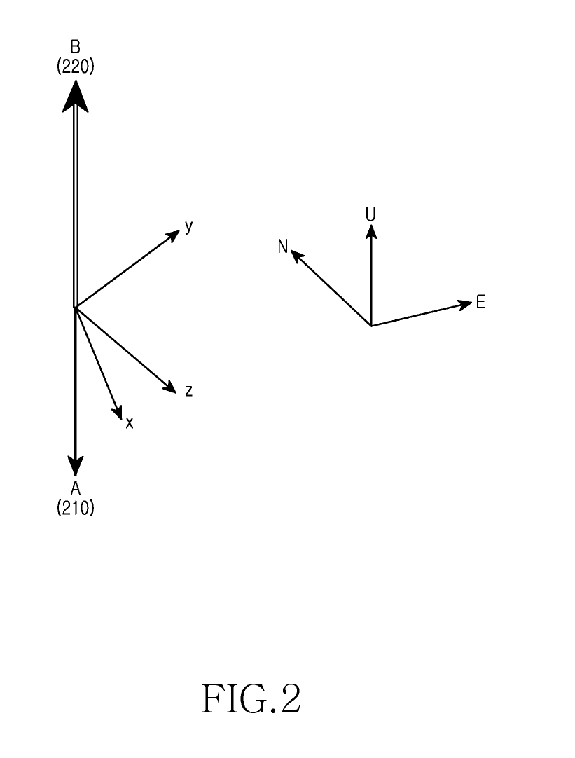

FIGS. 2 to 4 illustrate directions of an acceleration of gravity component vector and a rotational axis component vector depending on a movement form of a navigating body, according to embodiments of the present invention.

FIG. 2 illustrates an acceleration of gravity component vector and a rotational axis component vector for a case where a navigating body rotates at a speed less than a set value on a horizontal plane whose roadbed is constant, according to an embodiment of the present invention. In FIG. 2, A 210 represents an acceleration of gravity component vector, and B 220 represents a rotational axis component vector. Since the navigating body rotates at a low speed on the horizontal plane whose roadbed is constant, horizontal rotation is only set to occur on an E-N plane. The acceleration of gravity component vector A 210 coincides with a gravitational direction, i.e., a -U-axis, and the rotational axis component vector coincides with U-axis. Therefore, a horizontal heading change is equal to the size of the rotational axis component vector B 220, and a vertical heading change is equal to zero. Since the acceleration of gravity component vector and the rotational axis component vector coincide with the—U-axis and the U-axis of the horizontal plane coordinate system, respectively, a process of transforming a terminal coordinate system component value to a horizontal plane coordinate component value may be omitted.

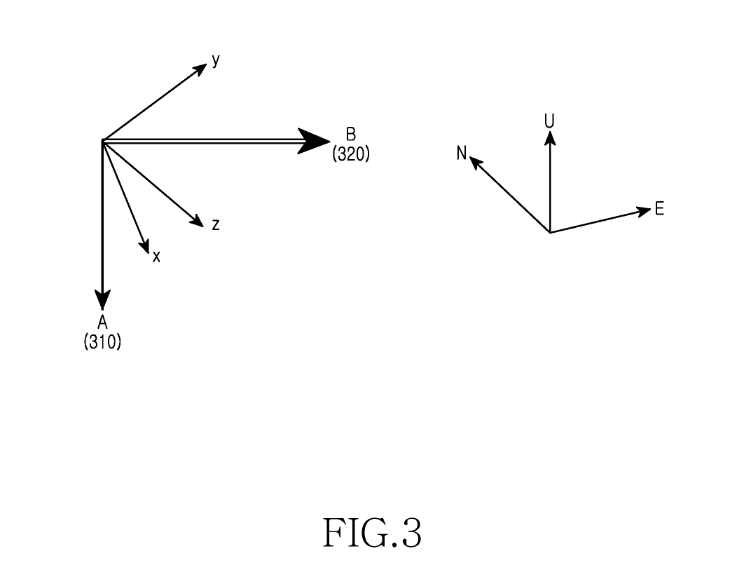

FIG. 3 illustrates an acceleration of gravity component vector and a rotational axis component vector for a case where a navigating body drives in a straight line at a constant speed on a roadbed including at least one of an uphill road, a downhill road, and an uneven road, according to an embodiment of the present invention. The navigating body rotates only vertically, and it is not a high operation state, so that an acceleration of gravity component vector A 310 is set to coincide with the—U-axis and a rotational axis component vector is set to coincide with one of the directions on an E-N plane, as illustrated in FIG. 3. A horizontal heading change with respect to the horizontal plane is 0, and a vertical heading change is equal to the size of a rotational axis component vector B 320. For example, the acceleration of gravity component vector and the rotational axis component vector as illustrated in FIG. 3 may be observed in the case where a navigating body drives in a straight line at a constant speed on a roadbed including at least one of an uphill road, a downhill road, and an uneven road.

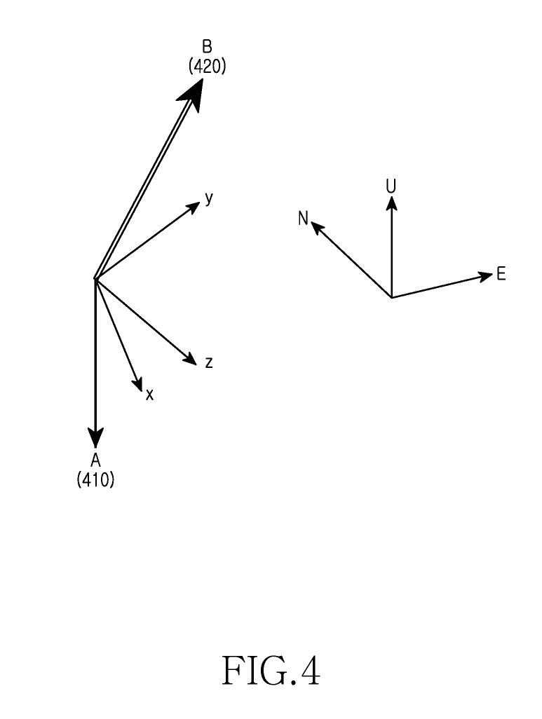

FIG. 4 illustrates an acceleration of gravity component vector and a rotational axis component vector for a case where a navigating body rotates at a speed less than a set value on a roadbed including at least one of an uphill road, a downhill road, and an uneven road, according to an embodiment of the present invention. The navigating body is not a high operation state, so that an acceleration of gravity component vector A 410 is set to coincide with the—U-axis, as illustrated in FIG. 4. However, since the navigating body generates both horizontal rotation and vertical rotation, a rotational axis component vector B 420 does not coincide with one of directions on the E-N plane or the U-axis. For example, the acceleration of gravity component vector and the rotational axis component vector as illustrated in FIG. 3 may be observed in the case where a navigating body rotates in low speed less than a set value on a roadbed including at least one of an uphill road, a downhill road, and an uneven road.

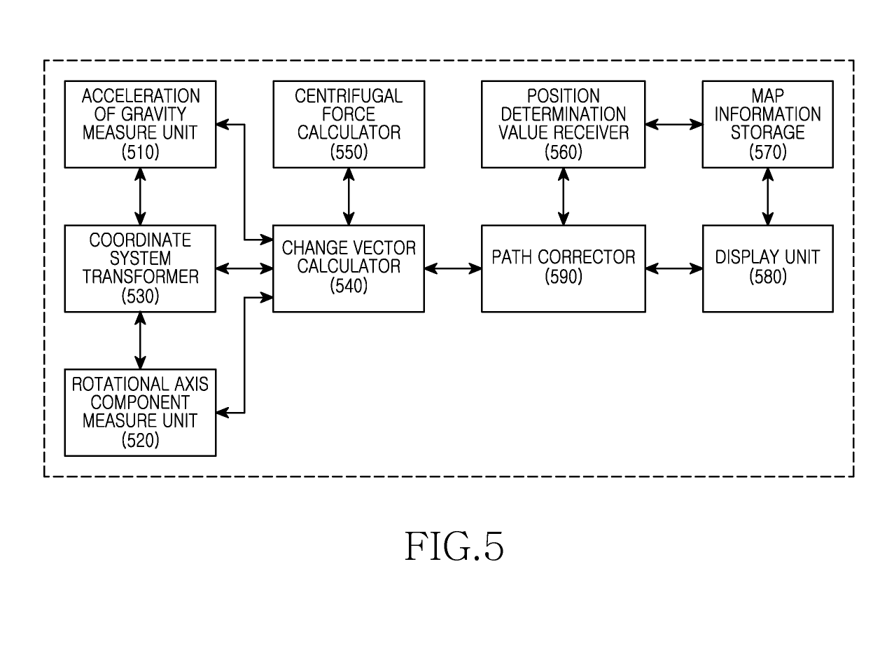

FIG. 5 is a block diagram illustrating a mobile terminal, according to an embodiment of the present invention.

As illustrated in FIG. 5, the mobile terminal may include an acceleration of gravity measure unit 510, a rotational axis component measure unit 520, a coordinate system transformer 530, a change vector calculator 540, a centrifugal force calculator 550, a position determination value receiver 560, a map information storage 570, a display unit 580, and a path corrector 590.

The acceleration of gravity measure unit 510 measures an acceleration of gravity component vector on a terminal coordinate system fixed to the mobile terminal. The acceleration of gravity measure unit 510 may measure an acceleration of gravity component vector at a current position using an acceleration sensor installed in the mobile terminal. Since the acceleration sensor is fixed on the terminal coordinate system, the measured acceleration of gravity component vector may be expressed in terms of the terminal coordinate system values.

The rotational axis component measure unit 520 measures a rotational axis component vector with respect to rotation of a navigating body on the terminal coordinate system fixed to the mobile terminal. The rotational axis component measure unit 520 may measure a rotational axis component vector by rotation of the navigating body using a gyroscope sensor installed to the mobile terminal. Since the gyroscope sensor is fixed on the terminal coordinate system, the measured rotational axis component vector may be expressed in terms of terminal coordinate system values.

The coordinate system transformer 530 transforms an acceleration of gravity component vector and a rotational axis component vector expressed in terms of terminal coordinates system values into components on a coordinate system fixed to the horizontal plane. Specifically, since absolute directions of respective axes of the terminal coordinate system change depending on, for example, an installation position, an installation direction of the mobile terminal, or a rotation of a navigating body, the terminal coordinate system cannot be used as a coordinate system for calculating the heading change. Therefore, the coordinate system transformer 530 transforms the acceleration of gravity component vector and the rotational axis component vector displayed in terms of the terminal coordinate system values to horizontal coordinate system values where absolute directions of respective axes are constant.

The change vector calculator 540 calculates a horizontal heading change vector and a vertical heading change vector based on an acceleration of gravity component vector and a rotational axis component vector. When a navigating body rotates at a low speed less than a set value or drives at a straight line in constant speed, it may be assumed that an acceleration of gravity component vector A coincides with the—U-axis, and a horizontal heading change vector and a vertical heading change vector may be calculated using Equation (1) and Equation (2).

$$Horizontal heading change vector = \frac{\vec{A} \cdot \vec{B}}{{\vert A \vert}^{2}} \times A \qquad ( 1 )$$

In Equation (1), A is an acceleration of gravity component vector and B is a rotational axis component vector.

Vertical heading change vector=B−horizontal heading change vector (2)

In Equation (2), B is a rotational axis component vector.

When a navigating body rotates at a speed greater than a set value, a direction of an acceleration of gravity component vector A may not coincide with the—U-axis due to centrifugal force, and a degree of non-coincidence is proportional to the size of the centrifugal force. The centrifugal force calculator 550 may calculate centrifugal force based on a rate of change in a rotational angle and a rotational radius of the navigating body. The change vector calculator 540 may reflect the calculated centrifugal force to correct the vertical heading change vector and the horizontal heading change vector.

The position determination value receiver 560 periodically receives a position determination value with respect to a current position from a GPS satellite. According to an embodiment of the present invention, the position determination value receiver 560 may receive the position determination value from other navigation sensors besides the GPS satellite. The map information storage 570 stores map information, and the display unit 580 may display map information corresponding to the position determination value received via the position determination value receiver 560 on a screen of the mobile terminal, and display a path from a current position to a destination set by a user. The mobile terminal may further include a speaker for voice guidance. The display unit 580 and the speaker may be denoted as an output unit.

When a branching road exists on the path from the current position to the destination, or an error exists in a received position determination value, the path corrector 590 may correct the path displayed on the display unit 580 based on the horizontal heading change vector and the vertical heading change vector calculated by the change vector calculator 540. For example, when an elevated road exists on a path from a current position to a destination, it can be determined that a navigating body enters the elevated road based on the vertical heading change vector calculated by the change vector calculator 540, and accordingly, the navigating body entering the elevated road may be accurately displayed on map information.

In addition, when a road branches inside an underground road or a position determination value from a GPS or other navigation sensors is not accurate in a downtown, a direction in which a navigating body has rotated may not be detected. A direction in which the navigating body has actually rotated may be accurately detected using a horizontal heading change vector calculated by the change vector calculator 540, and accordingly, a path of map information may be accurately corrected.

The heading calculated by the change vector calculator 540 may be utilized for correction of a position received from the position determination receiver 560 such as a GPS, a velocity, heading, etc. as in Equation (3) and Equation (4).

xₖ₊₁Φxₖ+wₖ (3)

In Equation (3), xₖ is a state variable vector of a system in a k-th sample, Φ is a system matrix modeled with consideration of motion dynamics of a navigating body system, and wₖ is a modeling error vector in a k-th sample.

zₖ=Hxₖ+vₖ (4)

In Equation (4), zₖ is a measurement value vector in a k-th sample, H is an observation matrix representing correlation between a measurement value vector and a system state variable vector, xₖ is a state variable vector of a system in a k-th sample, and vₖ is an error vector of a measurement value.

In Equation (3) and Equation (4), xₖ may include physical quantities, such as a position coordinate, a velocity, an acceleration, or a direction of a navigating body, or a changed value thereof. In addition, zₖ may include physical quantities, such as a position coordinate measured by a GPS or other navigation sensors, a velocity, an acceleration, or heading, or a changed value thereof. Further, zₖ may include the heading measured by an inert sensor, or a changed value thereof. An appropriate error level of wₖ and vₖ is applied, and a Kalman filter or other probabilistic appraisal technique is applied, so that a state variable vector xₖ of a navigating body may be estimated. Specifically, physical quantities, such as a position coordinate, a velocity, an acceleration, or a direction of a navigating body, or a changed value thereof, may be estimated. The estimated result has an improved performance in a statistical aspect compared to information measured by a GPS or other navigation sensors only, or information measured by an inert sensor only.

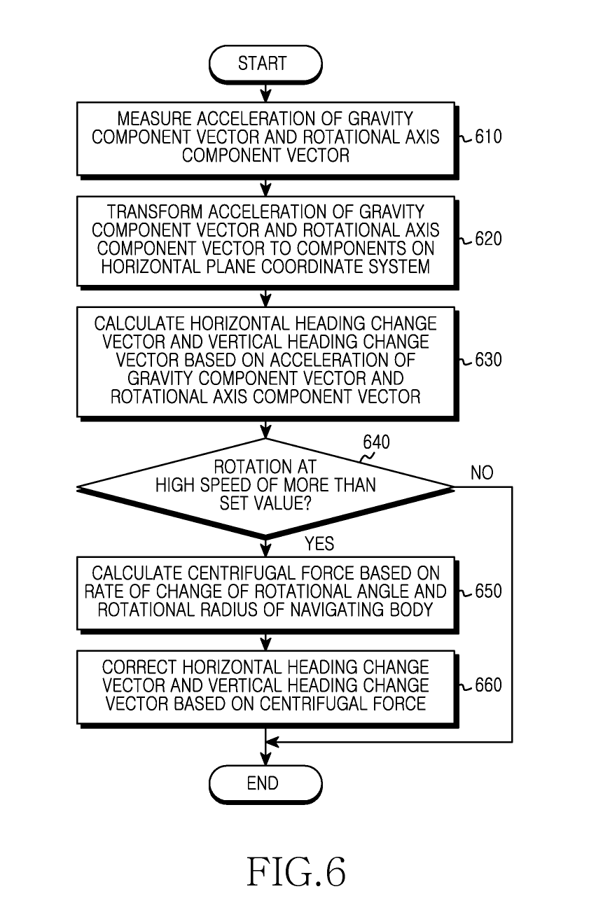

FIG. 6 is a flowchart illustrating a procedure for detecting heading change in a mobile terminal, according to an embodiment of the present invention.

Referring to FIG. 6, the mobile terminal measures an acceleration of gravity component vector and a rotational axis component vector, in step 610. The mobile terminal measures the acceleration of gravity component vector and the rotational axis component vector on a terminal coordinate system fixed to the mobile terminal. Accordingly, the acceleration of gravity component vector and the rotational axis component vector are expressed in terms of the terminal coordinate system. For example, the mobile terminal may use an acceleration sensor in order to measure the acceleration of gravity component vector, and may use a gyroscope sensor in order to measure the rotational axis component vector.

The mobile terminal transforms the acceleration of gravity component vector and the rotational axis component vector expressed in terms of the terminal coordinate values to values of the horizontal plane coordinate system fixed to the horizontal plane, in step 620. The mobile terminal calculates the horizontal heading change vector and the vertical heading change vector based on the acceleration of gravity component vector and the rotational axis component vector, in step 630. When a navigating body rotates at a low speed less than a set value or drives in a straight line at a constant speed, it is assumed that the acceleration of gravity component vector A coincides with the—U axis. A horizontal heading change vector and a vertical heading change vector may be calculated using Equation (1) and Equation (2).

The mobile terminal determines whether the navigating body is rotating at a speed, which is more than a set value, in step 640. When the navigating body rotates at the high speed, the mobile terminal proceeds to step 650. In contrast, when the navigating body does not rotate at the high speed, the mobile terminal terminates the methodology. When the navigating body rotates at the high speed, the mobile terminal calculates the centrifugal force based on a rate of change of a rotational angle and a rotational radius of the navigating body, in step 650. The mobile terminal proceeds reflects the calculated centrifugal force to correct the vertical heading change vector and the horizontal heading change vector, in step 660.

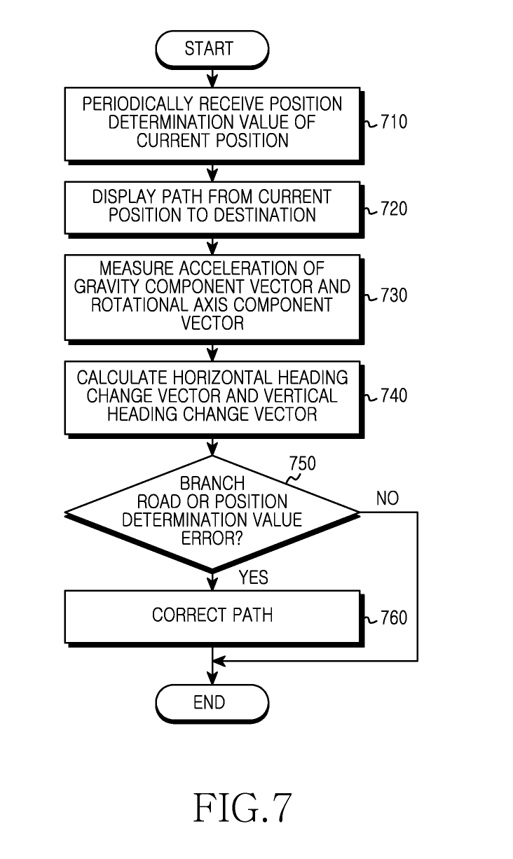

FIG. 7 is a flowchart illustrating a procedure for displaying a path in a mobile terminal, according to an embodiment of the present invention.

Referring to FIG. 7, the mobile terminal estimates the current position of a navigating body, and determines the position determination value in step 710. For example, the mobile terminal may periodically receive a position determination value of the current position from a GPS satellite or other navigation sensors.

The mobile terminal displays map information corresponding to the determined position determination value on a screen of the mobile terminal, and displays a path from the current position to a destination set by a user, in step 720. Specifically, the mobile terminal stores the map information.

The mobile terminal measures an acceleration of a gravity component vector on the terminal coordinate system fixed to the terminal using the acceleration sensor, and measures a rotational axis component vector with respect to the rotation of the navigating body on the terminal coordinate system fixed to the mobile terminal using the gyroscope sensor, in step 730. In addition, the mobile terminal transforms the acceleration of gravity component vector and the rotational axis component vector expressed in terms of the terminal coordinate system to components on the coordinate system fixed to the horizontal plane, and calculates a horizontal heading change vector and a vertical heading change vector based on the acceleration of gravity component vector and the rotational axis component vector, in step 740.

The mobile terminal determines whether a branching road exists on a path from the current position to a destination, or whether an error exists in a received position determination value, in step 750. When a branching road exists on the path from the current position to the destination, or the error exists in the received position determination value, the mobile terminal corrects the path displayed on the display unit 508 based on the horizontal heading change vector and the vertical heading change vector, in step 760. For example, when an elevated road exists on the path from the current position to the destination, the mobile terminal can know whether the navigating body has entered the elevated road based on the vertical heading change vector, and accordingly, can accurately display whether the navigating body has entered the elevated road on the map information. When a branching road does not exist on the path from the current position to the destination, and the error does not exist in the received position determination value, the methodology terminates.

As described above, embodiments of the present invention may accurately detect rotational information of a navigating body, display the detection result to a user, or determine an accurate progression path. According to embodiments of the present invention, detection of whether the navigating body rotates is performed at a point of occurrence of actual rotation, and information regarding the degree of rotation may be provided continuously.

It is assumed that most navigation equipment does not deviate from a set path while a user inputs a destination and receives path guidance. Therefore, since the conventional navigation equipment cannot instantly determine whether to branch, when the navigating body arrives at a branching point, the navigation equipment displays a state where the vehicle branches off and moves along a set path via a User Interface (UI) before detecting whether the vehicle has actually branched. When the user has not actually branched, a result of showing a situation different from the actual situation occurs.

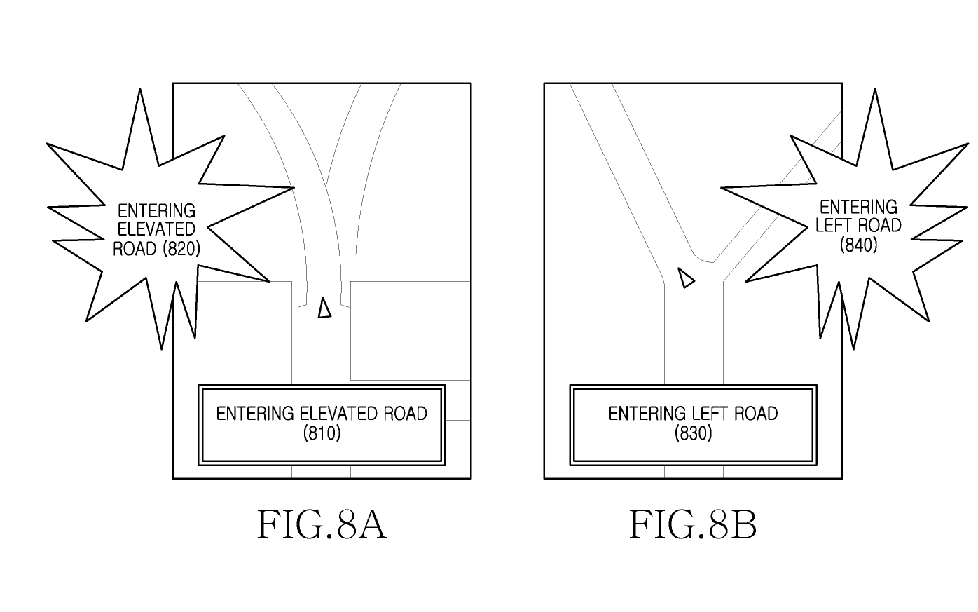

However, since embodiments of the present invention provide a quicker determination result as to whether the vehicle has rotated vertically/horizontally, the disadvantage of the conventional navigation equipments may be resolved. In an aspect of a UI, the mobile terminal according to embodiments of the present invention may provide whether it has rotated, which coincides with actual rotation, via a map UI. Specifically, the mobile terminal, according to an embodiment of the present invention may provide a continuous rotation figure coinciding with a figure of actual rotation via a 3-dimension (3D) or 2-dimension (2D) birdview map UI. In addition, the mobile terminal according to an embodiment of the present invention may provide information informing a path along which a vehicle actually drives using a determination result of a heading. For example, the mobile terminal according to an embodiment of the present invention may provide a UI, as illustrated in FIG. 8.

FIGS. 8A and 8B illustrate a UI for informing whether to diverge that is provided in a mobile terminal, according to an embodiment of the present invention. As illustrated in FIG. 8A, when a navigator enters an elevated road, the mobile terminal, according to an embodiment of the present invention, may determine whether a navigating body has entered the elevated road using a determination result of a heading in real time. Further, the mobile terminal provides an indication of whether the navigating body has entered the elevated road on the UI in the form of a pop-up 810 or a voice 820, for example. In addition, as illustrated in FIG. 8B, when a navigating body branches at a road branching point, the mobile terminal, according to an embodiment of the present invention, may determine a branch direction using the determination result of a heading in real time. Further, the mobile terminal provides the branch direction on the UI in the form of a pop-up 830 or a voice 840, for example. Though

FIGS. 8A and 8B illustrate only the branching point of the road and the elevated road, the UI of FIGS. 8A and 8B may be applied to a point where a road branches to other forms, such as, for example, an underground road.

The above-described method for detecting a heading change and the method for displaying a path may be stored in, for example, a magnetic recording medium or an optical recording medium, and may be executed by a computer.

According to embodiments of the present invention, a heading change may be detected and the detected heading change may be reflected and displayed, when an elevated road or an underground road exists in a path up to a destination when displaying the path from a current position to the destination using a mobile terminal detachable from a navigating body, or when an error exists in a position determination value.

While the invention has been shown and described with reference to certain embodiments thereof, it will be understood by those skilled in the art that various changes in form and detail may be made therein without departing from the spirit and scope of the invention as defined by the appended claims and their equivalents. Therefore, the scope of the present invention should not be limited to the above-described embodiments but should be determined by not only the appended claims but also the equivalents thereof.

What is claimed is:

1. A mobile terminal attachable to and detachable from a navigating body, the mobile terminal comprising:
at least one measure unit for measuring at least one of an acceleration of gravity component vector and a rotational axis component vector, with respect to a rotation of the navigating body, on a terminal coordinate system that is fixed in the mobile terminal; and
a change vector calculator for calculating a horizontal heading change vector and a vertical heading change vector based on at least one of the acceleration of gravity component vector and the rotational axis component vector.

2. The mobile terminal of claim 1, further comprising:
a coordinate system transformer for transforming the measured acceleration of gravity component vector and the measured rotational axis component vector into respective components of a horizontal plane coordinate system that is fixed in a horizontal plane.

3. The mobile terminal of claim 1, wherein, when the navigating body rotates at a speed that is less than a set value on a horizontal plane with a constant roadbed, the change vector calculator sets a direction of the acceleration of gravity component vector to coincide with a vertical downward axis of a horizontal plane coordinate system and a direction of the rotational axis component vector to coincide with a vertical upward axis of the horizontal plane coordinate system, to calculate the horizontal heading change vector and the vertical heading change vector.

4. The mobile terminal of claim 1, wherein, when the navigating body moves in a straight line at a constant speed on a roadbed comprising at least one of an uphill road, a downhill road, and an uneven road, the change vector calculator sets a direction of the acceleration of gravity component vector to coincide with a vertical downward axis of a horizontal plane coordinate system and a direction of the rotational axis component vector to coincide with a direction of a horizontal plane of the horizontal plane coordinate system, to calculate the horizontal heading change vector and the vertical heading change vector.

5. The mobile terminal of claim 1, wherein, when the navigating body moves at a speed that is less than a set value on a roadbed comprising at least one of an uphill road, a downhill road, and an uneven road, the change vector calculator sets a direction of the acceleration of gravity component vector to coincide with a vertical downward axis of a horizontal plane coordinate system, to calculate the horizontal heading change vector and the vertical heading change vector.

6. The mobile terminal of claim 1, further comprising:
a centrifugal calculator for, when the navigating body rotates at a speed that is greater than a set value, calculating a centrifugal force based on a rate of change of a rotational angle and a rotational radius of the navigating body,
wherein the change vector calculator calculates the horizontal heading change vector and the vertical heading change vector based on the acceleration of gravity component vector, the rotational axis component vector, and the centrifugal force.

7. The mobile terminal of claim 1, further comprising:
a position determination value receiver for periodically receiving a position determination value of a current position of the navigating body;
a map information storage for storing map information;
a display unit for displaying the map information corresponding to the position determination value received via the position determination value receiver, and a path from the current position to a destination set by a user of the mobile terminal; and
a path corrector for, when a branching road exists on the path from the current position to the destination, or an error exists in the received position determination value, correcting the path displayed on the display unit based on the horizontal heading change vector and the vertical heading change vector calculated by the change vector calculator.

8. The mobile terminal of claim 1, further comprising:
a path corrector for determining at least one of whether the navigating body has entered an elevated road, whether the navigating body has entered an underground road, and a progression direction at a road branching point; and
an output unit for outputting information informing a user of the mobile terminal of at least one of whether the navigating body has entered the elevated road, whether the navigating body has entered the underground road, and the progression direction at the road branching point.

9. The mobile terminal of claim 8, wherein the information informing the user of at least one of whether the navigating body has entered the elevated road, whether the navigating body has entered the underground road, and the progression direction at the road branching point comprises at least one of a pop-up window and a voice.

10. A method for operating a mobile terminal that is attachable to and detachable from a navigating body, the method comprising the steps of:
measuring at least one of an acceleration of gravity component vector and a rotational axis component vector, with respect to a rotation of the navigating body, on a terminal coordinate system that is fixed in the mobile terminal; and
calculating a horizontal heading change vector and a vertical heading change vector based on at least one of the acceleration of gravity component vector and the rotational axis component vector.

11. The method of claim 10, further comprising transforming the measured acceleration of gravity component vector and the measured rotational axis component vector into respective components of a horizontal plane coordinate system fixed in a horizontal plane.

12. The method of claim 10, wherein calculating the horizontal heading change vector and the vertical heading change vector comprises:
when the navigating body rotates at a speed that is less than a set value on a horizontal plane with a constant roadbed, setting a direction of the acceleration of gravity component vector to coincide with a vertical downward axis of a horizontal plane coordinate system, and setting a direction of the rotational axis component vector to coincide with a vertical upward axis of the horizontal plane coordinate system, to calculate the horizontal heading change vector and the vertical heading change vector.

13. The method of claim 10, wherein calculating the horizontal heading change vector and the vertical heading change vector comprises:
when the navigating body moves in a straight line at a constant speed on a roadbed comprising at least one of an uphill road, a downhill road, and an uneven road, setting a direction of the acceleration of gravity component vector to coincide with a vertical downward axis of a horizontal plane coordinate system, and setting a direction of the rotational axis component vector to coincide with a direction of a horizontal plane of the horizontal plane coordinate system, to calculate the horizontal heading change vector and the vertical heading change vector.

14. The method of claim 10, wherein calculating the horizontal heading change vector and the vertical heading change vector comprises:
when the navigating body moves at a speed that is less than a set value on a roadbed comprising at least one of an uphill road, a downhill road, and an uneven road, setting a direction of the acceleration of gravity component vector to coincide with a vertical downward axis of a horizontal plane coordinate system to calculate the horizontal heading change vector and the vertical heading change vector.

15. The method of claim 10, further comprising, when the navigating body rotates at a speed that is greater than a set value, calculating a centrifugal force based on a rate of change of a rotational angle and a rotational radius of the navigating body,
wherein the calculating of the horizontal heading change vector and the vertical heading change vector comprises calculating the horizontal heading change vector and the vertical heading change vector based on the acceleration of gravity component vector, the rotational axis component vector, and the centrifugal force.

16. The method of claim 10, further comprising:
periodically receiving a position determination value of a current position of the navigating body;
displaying map information corresponding to the position determination value received via the position determination value receiver, and a path from the current position to a destination set by a user of the mobile terminal; and
when a branching road exists on the path from the current position to the destination, or an error exists in the received position determination value, correcting the path displayed on the display unit based on the horizontal heading change vector and the vertical heading change vector calculated by the change vector calculator.

17. The method of claim 10, further comprising:
determining at least one of whether the navigating body has entered an elevated road, whether the navigating body has entered an underground road, and a progression direction at a road branching point; and
outputting information informing a user of the mobile terminal of at least one of whether the navigating body has entered the elevated road, whether the navigating body has entered the underground road, and the progression direction at the road branching point.

18. The method of claim 17, wherein the information informing the user of at least one of whether the navigating body has entered the elevated road, whether the navigating body has entered the underground road, and the progression direction at the road branching point comprises at least one of a pop-up window and a voice.

19. A mobile terminal comprising:
an acceleration of gravity measure unit for measuring an acceleration of gravity component vector on a terminal coordinate system that is fixed in the mobile terminal;
a rotational axis component measure unit for measuring a rotational axis component vector with respect to a rotation of a navigating body in the terminal coordinate system;
a coordinate system transformer for transforming the measured acceleration of gravity component vector and the measured rotational axis component vector into respective components of a horizontal plane coordinate system that is fixed in a horizontal plane;
a change vector calculator for calculating a horizontal heading change vector and a vertical heading change vector based on the acceleration of gravity component vector and the rotational axis component vector;
a position determination value receiver for determining a current position of the navigating body;
a display unit for displaying a path from the current position to a destination set by a user of the mobile terminal; and
a path corrector for, when a branching road exists on the path from the current position to the destination, or an error exists in the received position determination value, correcting the path of the navigating body based on the horizontal heading change vector and the vertical heading change vector.
